(19) United States
(12) Patent Application Publication
(10) Pub. No.: US 2016/0089914 A1
(43) Pub. Date: Mar. 31, 2016

(54) INKJET PRINTING APPARATUS AND SKEW CORRECTING METHOD THEREBY

(71) Applicant: SCREEN Holdings Co., Ltd., Kyoto (JP)

(72) Inventors: Takaharu YAMAMOTO, Kyoto-shi (JP); Shinsuke YAMASHITA, Kyoto-shi (JP); Hiroaki KISHIDA, Kyoto-shi (JP); Kunio MURAJI, Kyoto-shi (JP)

(21) Appl. No.: 14/847,412

(22) Filed: Sep. 8, 2015

(30) Foreign Application Priority Data
Sep. 26, 2014 (JP) 2014-196823

(51) Int. Cl. B41J 13/26; B41J 11/00; B41J 2/01

(52) U.S. Cl. CPC B41J 13/26; B41J 2/01; B41J 11/002

(57) ABSTRACT

Provided is an inkjet printing apparatus discharging ink droplets onto a print medium to be transported successively for forming an image. The apparatus includes a print unit discharging the ink droplets onto the print medium to form the image, a heating roller disposed downstream of the print unit and winding the print medium for drying, and a downstream skew correcting device disposed downstream of the print unit and upstream of the heating roller, and correcting skew of the print medium.

### TECHNICAL FIELD

The present invention relates to an inkjet printing apparatus that discharges ink droplets onto a print medium to be transported successively to perform printing and dries the print medium subjected to the printing with a heating roller. The present invention also relates to a skew correcting method by the inkjet printing apparatus.

### BACKGROUND ART

In a currently-used apparatus that performs printing onto a long printing sheet, a print format has been switched from a transaction printing to POD (Print on Demand) printing. In the transaction printing, typical printing is performed onto continuous-form paper. In the POD printing, printing is often performed depending on a print medium such as exclusive paper for inkjet or coated paper. The POD printing requires high-accurate printing.

When the printing sheet is not skewed as illustrated in FIG. 2, a printing region with a given area at a certain density has no defective part and thus has only a normal part. On the other hand, when the printing sheet is skewed as illustrated in FIG. 3, defective parts are generated. The defective parts include printing unevenness, like white lines, for non-printable portions caused by clearances of inkjet heads in a staggered arrangement, and printing unevenness, like black lines, for portions where nozzles of the inkjet heads in the staggered arrangement overlap in a transportation direction.

Consequently, the following has been suggested. See, for example, Japanese Unexamined Patent Publication No. 2002-46912A. That is, transport rollers transport a long print medium, and a skew correcting mechanism corrects skew of the print medium. Thereafter, a print unit downstream of the skew correcting mechanism forms an image on the print medium. In addition, the following has been suggested. See, for example, Japanese Unexamined Patent Publication No. 2006-335516A. That is, first skew correction is performed, and thereafter the skew correction is again performed.

However, the examples of the currently-used apparatus with such configurations have the following problem.

Specifically, the currently-used apparatus performs skew correction once or twice on an upstream side of the print unit. However, skew cannot be eliminated completely, leading to printing failure mentioned above. Such a problem may arise.

### SUMMARY OF INVENTION

### Technical Problem

The present invention has been made regarding the state of the art noted above, and its one object is to provide an inkjet printing apparatus that allows suppression of printing failure caused by skew and a skew correcting method using the inkjet printing apparatus.

To fulfill the above object, Inventors have made intensive research and attained the following findings.

One example of inkjet printing apparatus includes a heating roller as a drive roller that transports a printing sheet while winding the printing sheet at a large winding angle. The heating roller dries the printing sheet subjected to printing with the print unit by contacting a peripheral surface thereof against the printing sheet. The heating roller has an axial length corresponding to the maximum width of the printing sheet used in the inkjet printing apparatus for application to various paper widths. It was found through printing results under different conditions that skew was unlikely to occur with a printing sheet having the maximum width, but skew was likely to occur with the printing sheet whose width is smaller than the maximum width. Accordingly, the Inventors discovered the following through analysis considering thermal expansion of the heating roller on the transport path. Specifically, when the printing sheet contacted the heating roller in an offset manner, i.e., when the center of the printing sheet in the width direction did not align with the center of the heating roller in the axial direction, the printing sheet has different temperatures between a surface contacting the heating roller and a surface not contacting the heating roller. In addition, even when the printing sheet contacted the heating roller uniformly, printing offset in the width direction of the printing sheet causes non-uniform temperatures between a printing part and a non-printable part. Consequently, some skew occurred due to non-uniform deformation of the heating roller upon the thermal expansion. In addition, the skew having occurred on the heating roller spread back to the upstream side around the print unit. In other words, the skew caused by the deformation of the heating roller spread upstream to degrade a printing accuracy, leading to printing failure. The present invention based on such finding is constituted as under.

One embodiment of the present invention discloses an inkjet printing apparatus discharging ink droplets onto a print medium to be transported successively for forming an image. The apparatus includes a print unit discharging the ink droplets onto the print medium to form the image; a heating roller disposed downstream of the print unit and winding the print medium for drying; and a downstream skew correcting device disposed downstream of the print unit and upstream of the heating roller, and correcting skew of the print medium.

With the embodiment of the present invention, the skew correcting device, disposed downstream of the print unit and upstream of the heating roller, corrects the skew of the print medium. Consequently, the skew caused by deformation of the heating roller can be prevented from spreading upstream. As a result, printing failure caused by the skew can be suppressed.

Moreover, it is preferable that the downstream skew correcting device according to the embodiment of the present invention moves an end of the print medium, orthogonal to a transportation direction of the print medium, in an intersecting direction with respect to a surface of the print medium in side view.

Moving the end of the print medium in the intersecting direction with respect to the surface of the print medium allows movement of the print medium toward the end thereof. This achieves adjustment of a degree of skew of the print medium.

Moreover, it is preferable that the downstream skew correcting device according to the embodiment of the present invention includes a transport roller disposed in a direction orthogonal to the transportation direction of the print medium and contacting against the print medium to transport the print medium in the transportation direction, and a moving device moving at least one end face of the transport roller in the intersecting direction.

The moving device moves at least one end face of the transport roller in the intersecting direction with respect to the surface of the print medium. This allows adjustment of the degree of skew of the print medium.

Moreover, it is preferable that the transport roller according to the embodiment of the present invention includes bearings on its both end faces individually, and the moving device includes a housing covering at least one of the bearings, a guide shaft guiding the housing in the intersecting direction, a screw shaft provided along the guide shaft and screwed into the housing, and a motor rotating the screw shaft.

Operating the motor causes the screw shaft to rotate, whereby the housing is moved along the guide shaft. Accordingly, at least one of the bearings is moved in the intersecting direction with respect to the surface of the print medium. Consequently, controlling the number of rotations and rotational directions of the motor allows control of the skew of the print medium.

It is also preferable that the bearings according to the embodiment of the present invention are each of an automatic alignment type.

The automatic alignment bearings achieve maintained smooth rotation even when the transport roller is inclined. Consequently, the transport roller allows maintained smooth transportation of the print medium.

Moreover, another embodiment of the present invention discloses a skew correcting method by an inkjet printing apparatus that discharges ink droplets onto a print medium to be transported successively to form an image. The method includes an image forming step of forming the image by causing a print unit to discharge the ink droplets onto the print medium; a skew correcting step of correcting skew of the print medium, with the image formed thereon, by a downstream skew correcting device disposed downstream of the print unit and upstream of a heating roller; and a drying step of drying the print medium, with the image formed thereon, by winding the print medium around the heating roller.

With the embodiment of the present invention, the print unit forms the image on the print medium in the image forming step, and the downstream skew correcting device disposed downstream of the print unit corrects the skew of the print medium in the skew correcting step. In the drying step, the print medium with the image formed thereon is wound around the heating roller for drying. Here, the skew caused by the heating roller is corrected with the downstream skew correcting device. Accordingly, the skew is prevented from spreading upstream. This results in suppressed printing failure due to the skew.

### BRIEF DESCRIPTION OF DRAWINGS

For the purpose of illustrating the invention, there are shown in the drawings several forms which are presently preferred, it being understood, however, that the invention is not limited to the precise arrangement and instrumentalities shown.

FIG. 1 schematically illustrates an overall configuration of an inkjet printing system according to one embodiment of the present invention.

FIG. 2 is a schematic view of a printing result with no skew.

FIG. 3 is a schematic view of a printing result with skew.

FIG. 4 is a detailed longitudinal sectional view of a skew correcting mechanism seen from a transportation direction.

FIG. 5 illustrates operation of the skew correcting mechanism.

FIG. 6 illustrates operation of a skew correcting mechanism according to one modification of the present invention.

### DESCRIPTION OF EMBODIMENTS

The following describes preferred embodiments of the present invention with reference to drawings.

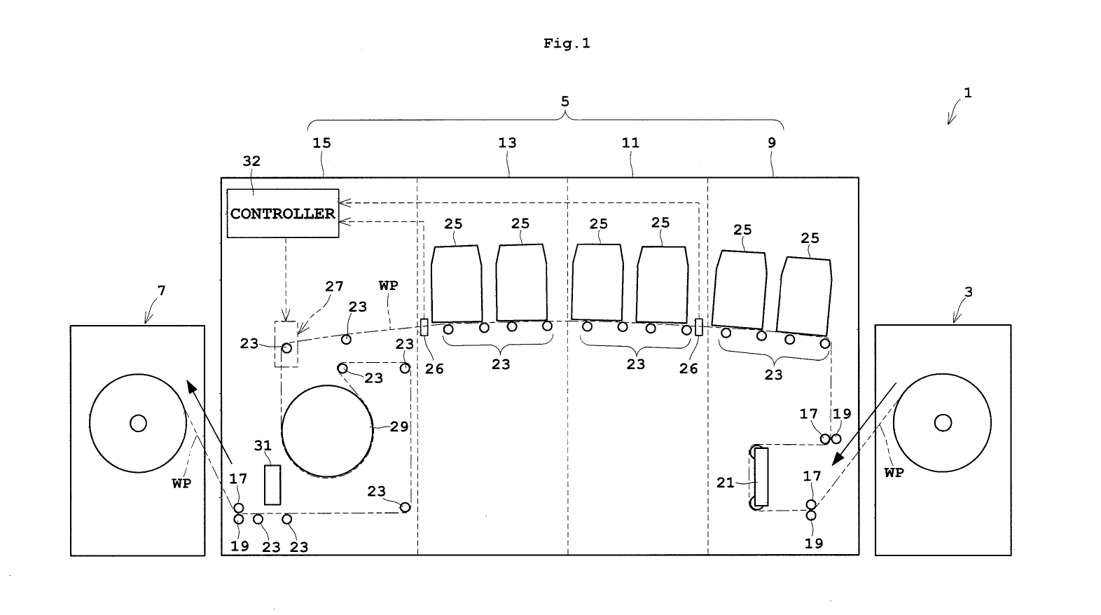

FIG. 1 schematically illustrates an overall configuration of an inkjet printing system according to one embodiment of the present invention.

An inkjet printing system 1 according to the embodiment includes a paper feeder 3, an inkjet printing apparatus 5, and a take-up roller 7.

The paper feeder 3 holds web paper WP in a roll form to be rotatable about a horizontal axis, and unwinds the web paper WP to feed it to the inkjet printing apparatus 5. The inkjet printing apparatus 5 performs printing to the web paper WP. The take-up roller 7 winds up the web paper WP printed by the inkjet printing apparatus 5 about the horizontal axis. Regarding the side from which the web paper WP is fed as upstream and the side to which the web paper WP is taken up as downstream, the paper feeder 3 is disposed upstream of the inkjet printing apparatus 5 whereas the take-up roller 7 is disposed downstream of the inkjet printing apparatus 5.

Here, the web paper WP corresponds to the “print medium” in the present invention.

The inkjet printing apparatus 5 includes an inlet unit 9, a first intermediate unit 11, a second intermediate unit 13, and an outlet unit 15, in this order from a side adjacent to the paper feeder 3. The inkjet printing apparatus 5 in the present embodiment is formed by selectively connecting the above units 9, 11, 13, and 15 appropriately.

The inlet unit 9 includes a drive roller 17, a nip roller 19, an edge position controller 21, a drive roller 17, a nip roller 19, four transport rollers 23, and two inkjet heads 25 in this order from the side adjacent to the paper feeder 3. The drive roller 17 and the nip roller 19 take the web paper WP from the paper feeder 3. When the web paper WP skews, the edge position controller 21 automatically suppresses a variation in edge position of the web paper WP.

Here, the edge position controller 21 corresponds to the “upstream skew correcting device” in the present invention.

The four transport rollers 23 contact against an undersurface of the web paper WP for transporting the web paper WP smoothly. The inkjet heads 25 each discharge ink droplets onto the web paper WP for forming an image. Here, an upstream inkjet head 25 discharges ink droplets in black (K), and a downstream inkjet head 25 discharges ink droplets in cyan (C). The four transport rollers 23 form a transport path at upper faces thereof for transporting the web paper WP.

The first intermediate unit 11 includes four transport rollers 23 and two inkjet heads 25. An upstream inkjet head 25 of the two inkjet heads 25 discharges ink droplets in magenta (M), and a downstream inkjet head 25 discharges ink droplets in yellow (Y).

The second intermediate unit 13 has the same configuration as that of the first intermediate unit 11. That is, the second intermediate unit 13 includes four transport rollers 23 and two inkjet heads 25. An upstream inkjet head 25 of the two inkjet heads 25 discharges ink droplets in gold, and a downstream inkjet head 25 discharges an overcoating material. The overcoating material is used for covering a surface of the printed image for protection.

Position sensors 26 are disposed upstream of the first intermediate unit 11 and downstream of the second intermediate unit 13 individually.

The position sensors 26 each detect an edge of the web paper WP at a position where the position sensors 26 are disposed. The position sensors 26 output signals by which a degree of skew and a direction of the skew of the web paper WP are determinable.

Here, the inkjet heads 25 correspond to the “print unit” in the present invention.

The outlet unit 15 includes a transport roller 23, a skew correcting mechanism 27, a heating roller 29, an inspecting unit 31, a drive roller 17, and a nip roller 19, in this order from upstream of the transport path. The skew correcting mechanism 27, details of which is to be described later, corrects the skew of the web paper WP between the heating roller 29 and the inkjet heads 25. The heating roller 29 includes a heating device, such as a heater, embedded therein. The heating roller 29 transports the web paper WP while winding the web paper WP at a large winding angle. The heating roller 29 winds the web paper WP around a periphery surface thereof for drying the ink droplets discharged on the web paper WP. The heating roller 29 has a length in an axial direction (a depth direction in direction FIG. 1) corresponding to the maximum width of the web paper WP used in the inkjet printing apparatus 5 for application to various paper widths. The inspecting unit 31 inspects the printed image in the web paper WP for any printing defects such as stains or omissions.

Here, the skew correcting mechanism 27 corresponds to the “downstream skew correcting device” in the present invention.

The above components are controlled en bloc by a controller 32 with a CPU and a memory. The controller 32 receives the output signals from the two position sensors 26, and operates a motor 51 to be mentioned later.

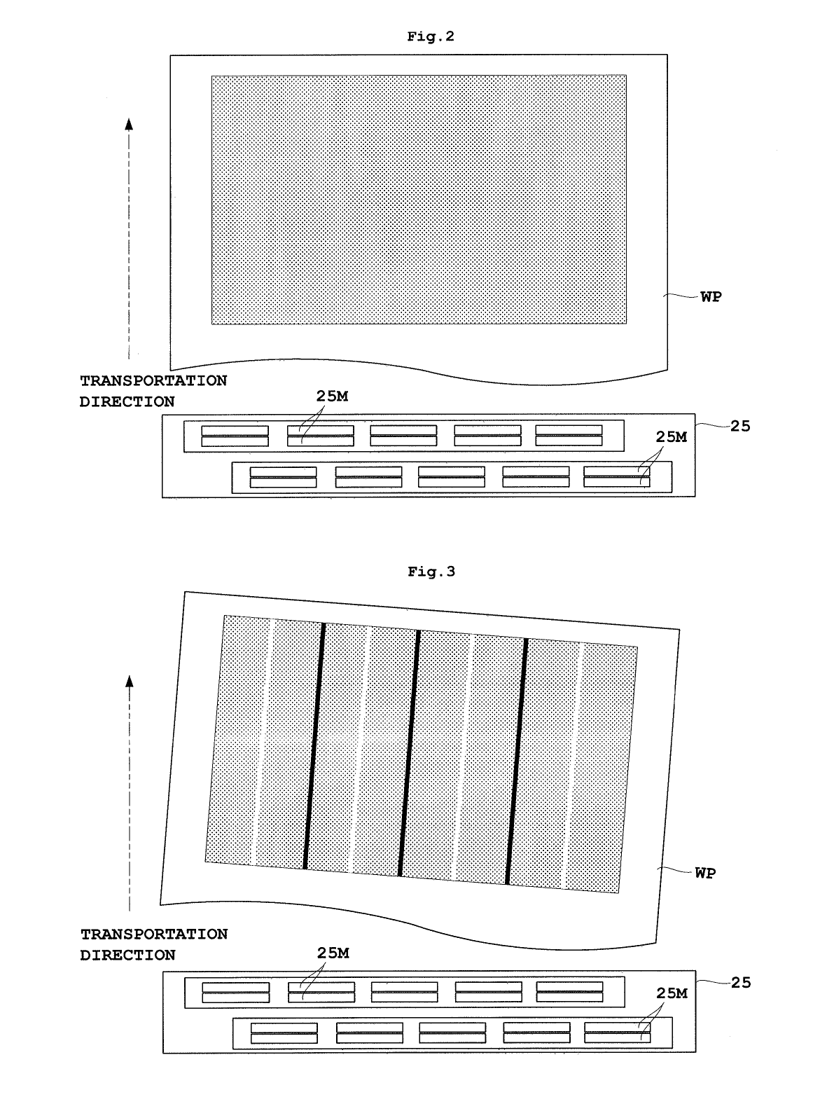

Reference is now made to FIGS. 2 and 3. FIG. 2 is a schematic view of a printing result with no skew. FIG. 3 is a schematic view of a printing result with skew.

As mentioned above, the web paper WP is fed out from the paper feeder 3, and is subjected to printing with the inkjet heads 25. The inkjet heads 25 each include a plurality of head modules 25M arranged in a staggered manner. Consequently, when the inkjet heads 25 perform printing onto a given area at a constant density, printing with no defective portion as in FIG. 2 is obtainable when the web paper WP does not skew. On the other hand, when the web paper WP skews, clearances among the head modules 25M in the staggered manner cause non-printable parts as printing unevenness like white lines. In addition, overlapped nozzles of the head modules 25M in the staggered arrangement in the transportation direction causes another printing unevenness like black lines. Such printing unevenness like white and black lines leads to printing failure.

Such printing failure can be suppressed to some extent by operation of the edge position controller 21. However, this achieves insufficient suppression of the skew of the web paper WP. The Inventors have made intensive research and focused on attention that the skew is likely to occur with the web paper WP whose width is smaller than the maximum width thereof. Accordingly, the Inventors discovered the following through analysis results considering thermal expansion of the heating roller 29. That is, the web paper WP skews from non-uniform deformation upon expansion of the heating roller 29. Specifically, when the web paper WP is contacted against the heating roller 29 in an offset manner, i.e., when the center of the web paper WP in the width direction does not align with the center of the heating roller 29 in the axial direction, the web paper WP has different temperatures between a surface contacting the heating roller 29 and a surface not contacting the heating roller 29. Consequently, non-uniform deformation occurs upon the thermal expansion of the heating roller 29. In addition, even when the web paper WP is contacted against the heating roller 29 uniformly, printing offset in the width direction of the web paper WP causes non-uniform temperatures among a printing part and a non-printable part. Consequently, non-uniform deformation also occurs upon the thermal expansion of the heating roller 29. It has also been discovered that the skew on the heating roller 29 spread back to upstream and also around the inkjet heads 25. In other words, the skew caused by the deformation of the heating roller 29 spread upstream to degrade a printing accuracy, leading to printing failure.

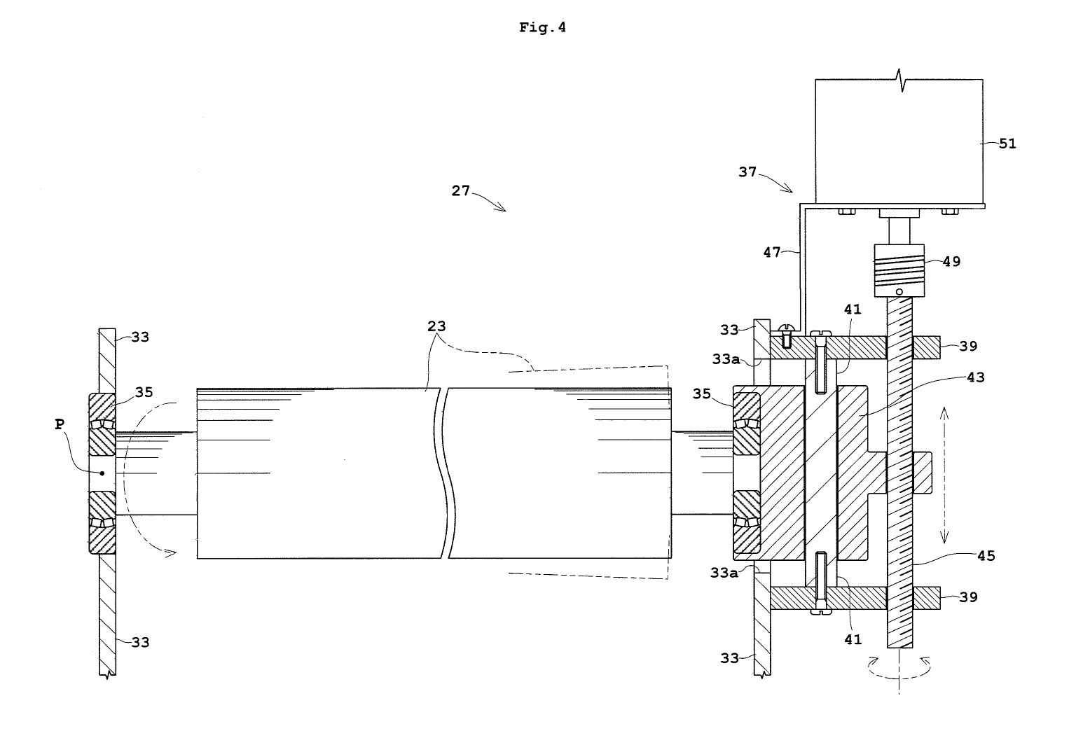

In order to suppress such upstream spread of the skew caused by the heating roller 29, the inkjet printing apparatus 5 according to the present embodiment includes the skew correcting mechanism 27 (downstream skew correcting device).The following describes the skew correcting mechanism 27 with reference to FIG. 4. FIG. 4 is a detailed longitudinal sectional view of the skew correcting mechanism seen from the transportation direction.

The skew correcting mechanism 27 is, for example, disposed adjacent to one of side plates 33 erected laterally along the transport path. The transport roller 23 having automatic alignment bearings 35 on its both end faces individually is disposed between the side plates 33. The automatic alignment bearings 35 each have an outer ring whose inner wall has a spherical orbit. The center of curvature of the orbit matches with the center of bearing P. An inner ring rotates with respect to the outer ring smoothly even when the inner ring is inclined relative to an axis of the transport roller 23. The transport roller 23 is attached to the inner rings of the automatic alignment bearings 35, and is attached to the side plates 33 at the outer rings of the automatic alignment bearings 35. It should be noted that only one of the automatic alignment bearings 35 (the left in FIG. 4) is fixedly attached to one of the side plate 33, and the other automatic alignment bearing 35 (the right in FIG. 4) is movably attached to the other of the side plates 33 via moving mechanism 37.

The moving mechanism 37 includes a holder frame 39, a guide shaft 41, a housing 43, a screw shaft 45, an attaching plate 47, a cup ring 49, and a motor 51. Here, the moving mechanism 37 corresponds to the “moving device” in the present invention.

The holder frame 39 is formed by a pair of plates. The plates are disposed vertically across an opening 33a on the right side plate 33, and are attached outside the right side plate 33. The holder frame 39 includes the housing 43 inside thereof into which the vertical guide shaft 41 is inserted. The housing 43 is attached to the right automatic alignment bearing 33 so as to be fixed on only the outer ring of the automatic alignment bearing 33. The guide shaft 41 guides the housing 43 inside the holder frame 39 vertically. The housing 43 is screwed at an outer end thereof in the screw shaft 45. The screw shaft 45 is disposed in parallel with the guide shaft 41, and both ends thereof protrude from the holder frame 39. A lateral L-shaped attaching plate 47 is attached to an upper holder frame 39. The cup ring 49 is attached to an upper end of the screw shaft 45. The screw shaft 45 is attached to a rotary shaft of the motor 51 on the attaching plate 47 via the cup ring 49.

When the moving mechanism 37 operates, the screw shaft 45 rotates around its axis to cause the housing 43 to move vertically along the guide shaft 41. In other words, the housing 43 is moved in an intersecting direction with respect to the surface of the web paper WP in side view. Consequently, as illustrated in FIG. 4 by chain double-dashed lines, the transport roller 23 turns about the bearing center P of the left automatic alignment bearing 33.

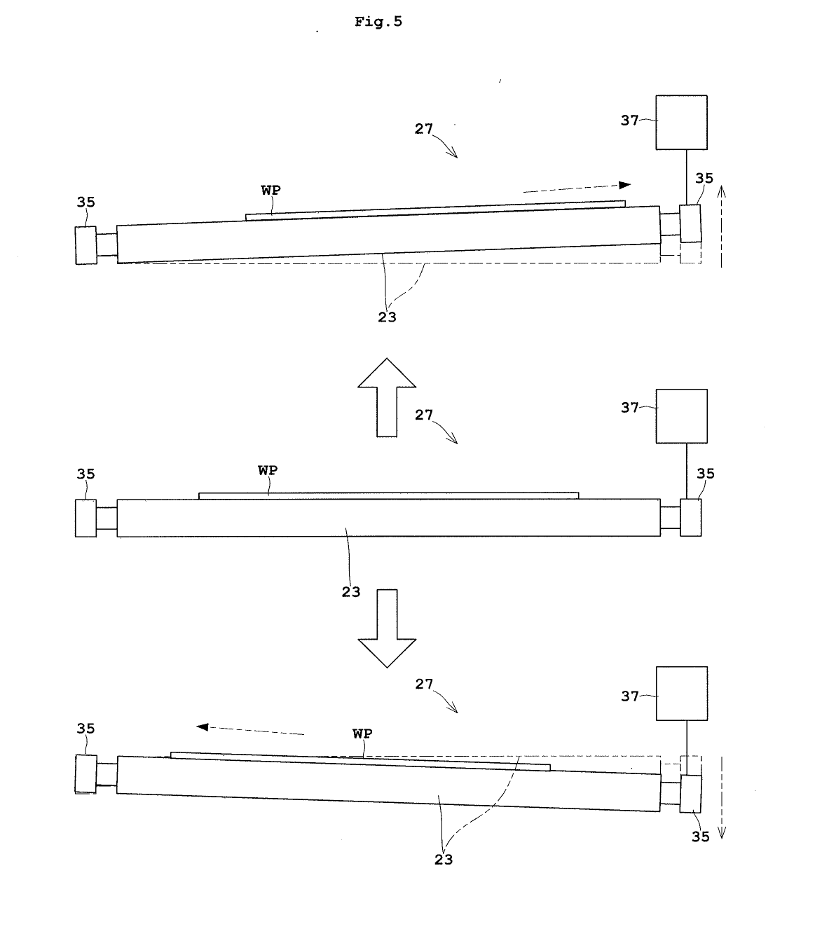

Reference is made to FIG. 5. FIG. 5 is an explanatory view of operation of the skew correcting mechanism.

When the moving mechanism 37 operates to move the right side of the transport roller 27 upward as illustrated in the upper drawing of FIG. 5, the web paper WP gradually slides up to the right. On the other hand, when the right side of the transport roller 27 is moved downward as illustrated in the lower drawing of FIG. 5, the web paper WP gradually slides up to the left. As noted above, operation of the moving mechanism 37 so as for the right side of the transport roller 27 to be moved vertically allows movement of the edge of the web paper WP for achieving suppression of the skew. Such operation of the moving mechanism 37 is conducted by a controller 32 in accordance with the output signals from the position sensors 26.

In the inkjet printing system 1 formed in the above manner, the web paper WP is fed out from the paper feeder 3. The web paper WP is transported while the edge position thereof is controlled by the edge position controller 21, and the inkjet heads 25 discharge ink droplets onto the web paper WP to print an image (image forming step). The web paper WP passes through the skew correcting mechanism 27 to be subjected to skew correction (skew correcting step) while the printed parts of the web paper WP is wound around the heating roller 29 to be dried with heat (drying step). At this time, the skew spreads back upstream to the inkjet heads 25 due to outer deformation of the heating roller 29. However, the skew correcting mechanism 27 corrects the skew of the web paper WP. This allows prevention of upstream spread of the skew caused by the heating roller 29.

With the present embodiment, the skew correcting mechanism 27 downstream of the inkjet heads 25 and upstream of the heating roller 29 corrects the skew of the web paper WP. Consequently, the skew can be prevented from spreading upstream. Here, the skew occurs from misalignment of the center of the web paper WP in the width direction with the axial center of the heating roller 29. Alternatively, the skew occurs from deformation of the heating roller 29 due to non-uniform temperatures from printing offset of the web paper WP in the width direction. This results in printing failure caused by the skew.

Moreover, the moving mechanism 37 operates the motor 51 to cause the screw shaft 45 to rotate and cause the housing 43 to move along the guide shaft 41. Accordingly, one of the automatic alignment bearings 35 is moved in the intersecting direction with respect to the surface of the web paper WP. Consequently, the controller 32 controls the number of rotations and the rotational directions of the motor 51 in accordance with the output signals from the position sensors 26, allowing suppression of the skew of the web paper WP.

The present invention is not limited to the foregoing examples, but may be modified as follows.

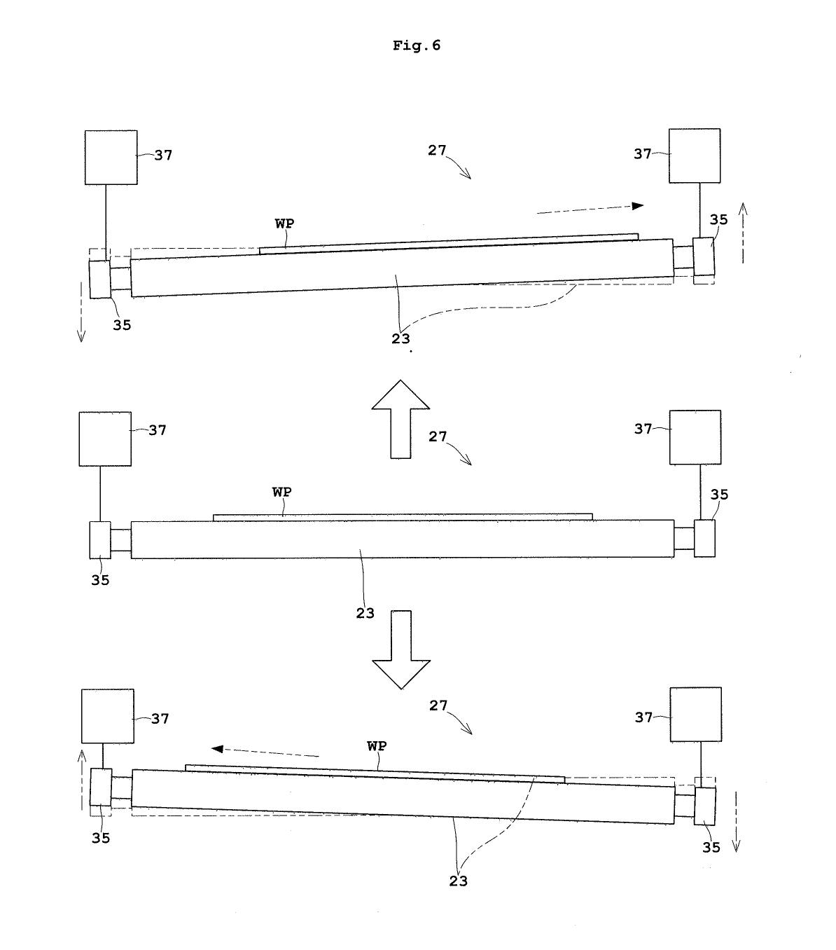

(1) In the embodiment mentioned above, the moving mechanism 37 moves the right automatic alignment bearing 35 in FIG. 4 vertically. Alternatively, the moving mechanism 37 may move the left automatic alignment bearing 35 vertically. In addition, as illustrated in FIG. 6, the moving mechanism 37 may move both the automatic alignment bearings 35 in directions opposite to each other. Consequently, movement in opposite directions allows rapid inclination of the transport roller 23, achieving early suppression of the skew.

(2) In the embodiment mentioned above, the moving mechanism 37 moves the automatic alignment bearing 35 vertically. Alternatively, in the present invention, the moving mechanism 37 may merely move the automatic alignment bearing 35 in the intersecting direction with respect to the surface of the side face in side view. That is, a longitudinal axis of the guide shaft 41 is disposed in a depth direction of the plane of FIG. 4, and the right automatic alignment bearing 35 is moved in the depth direction of the plane. Such a configuration may be adopted.

(3) In the embodiment mentioned above, the skew correcting mechanism 27 is disposed in the transport roller 23 adjacent to and immediately upstream of the heating roller 29. However, the present invention is not limited to such a configuration. For instance, the skew correcting mechanism 27 may be disposed any positions between the inkjet head 25 and the heating roller 29.

(4) In the embodiment mentioned above, the transport roller 23 operated by the skew correcting mechanism 27 includes the automatic alignment bearing 35. However, the present invention is not limited to such a configuration. For instance, the transport roller 23 includes a typical bearing whose outer ring is pivotally supported on the side plate 33.

(5) In the embodiment mentioned above, the web paper WP has been described as one example of the print medium. However, in the present invention, the print medium is not limited to the web paper WP. For instance, examples of the print medium include a film.

The present invention may be embodied in other specific forms without departing from the spirit or essential attributes thereof and, accordingly, reference should be made to the appended claims, rather than to the foregoing specification, as indicating the scope of the invention.

What is claimed is:

1. An inkjet printing apparatus discharging ink droplets onto a print medium to be transported successively for forming an image, the apparatus comprising:
a print unit discharging the ink droplets onto the print medium to form the image;
a heating roller disposed downstream of the print unit and winding the print medium for drying; and
a downstream skew correcting device disposed downstream of the print unit and upstream of the heating roller, and correcting skew of the print medium.

2. The inkjet printing apparatus according to claim 1, wherein
the downstream skew correcting device moves an end of the print medium, orthogonal to a transportation direction of the print medium, in an intersecting direction with respect to a surface of the print medium in side view.

3. The inkjet printing apparatus according to claim 2, wherein
the downstream skew correcting device comprises:
a transport roller disposed in a direction orthogonal to the transportation direction of the print medium and contacting against the print medium to transport the print medium in the transportation direction, and
a moving device moving at least one end face of the transport roller in the intersecting direction.

4. The inkjet printing apparatus according to claim 3, wherein
the transport roller comprises bearings on its both end faces individually, and
the moving device comprising:
a housing covering at least one of the bearings;
a guide shaft guiding the housing in the intersecting direction;
a screw shaft provided along the guide shaft and screwed into the housing; and
a motor rotating the screw shaft.

5. The inkjet printing apparatus according to claim 4, wherein
the bearings are each of an automatic alignment type.

6. The inkjet printing apparatus according to claim 1, further comprising:
an upstream skew correcting device disposed upstream of the print unit.

7. The inkjet printing apparatus according to claim 2, further comprising:
an upstream skew correcting device disposed upstream of the print unit.

8. The inkjet printing apparatus according to claim 3, further comprising:
an upstream skew correcting device disposed upstream of the print unit.

9. The inkjet printing apparatus according to claim 4, further comprising:
an upstream skew correcting device disposed upstream of the print unit.

10. The inkjet printing apparatus according to claim 5, further comprising:
an upstream skew correcting device disposed upstream of the print unit.

11. The inkjet printing apparatus according to claim 1, wherein
the downstream skew correcting device is disposed adjacent to the heating roller.

12. The inkjet printing apparatus according to claim 2, wherein
the downstream skew correcting device is disposed adjacent to the heating roller.

13. The inkjet printing apparatus according to claim 3, wherein
the downstream skew correcting device is disposed adjacent to the heating roller.

14. The inkjet printing apparatus according to claim 4, wherein
the downstream skew correcting device is disposed adjacent to the heating roller.

15. The inkjet printing apparatus according to claim 5, wherein
the downstream skew correcting device is disposed adjacent to the heating roller.

16. The inkjet printing apparatus according to claim 6, wherein
the downstream skew correcting device is disposed adjacent to the heating roller.

17. The inkjet printing apparatus according to claim 7, wherein
the downstream skew correcting device is disposed adjacent to the heating roller.

18. The inkjet printing apparatus according to claim 8, wherein
the downstream skew correcting device is disposed adjacent to the heating roller.

19. The inkjet printing apparatus according to claim 9, wherein
the downstream skew correcting device is disposed adjacent to the heating roller.

20. A skew correcting method by an inkjet printing apparatus that discharges ink droplets onto a print medium to be transported successively to form an image, the method comprising:
an image forming step of forming the image by causing a print unit to discharge the ink droplets onto the print medium;
a skew correcting step of correcting skew of the print medium, with the image formed thereon, by a downstream skew correcting device disposed downstream of the print unit and upstream of a heating roller; and
a drying step of drying the print medium, with the image formed thereon, by winding the print medium around the heating roller.
